(19) United States
(12) Patent Application Publication
(10) Pub. No.: US 2026/0326441 A1
(43) Pub. Date: Oct. 22, 2026

(54) METHOD FOR MANUFACTURING NOZZLE PLATE

(71) Applicant: KONICA MINOLTA, INC., Tokyo (JP)

(72) Inventors: Mitsuru YOKOYAMA, Takatsuki-shi, Osaka (JP); Kouichi SAMESHIMA, Kyoto-shi, Kyoto (JP)

(21) Appl. No.: 19/114,038

(22) PCT Filed: Sep. 15, 2023
(86) PCT No.: PCT/JP2023/033794

§ 371 Date: Mar. 21, 2025

(30) Foreign Application Priority Data
Sep. 22, 2022 (JP) 2022-151245

(51) Int. Cl. B41J 2/16

(52) U.S. Cl. CPC B41J 2/162; B41J 2/1629; B41J 2/1632

(57) ABSTRACT

A method for manufacturing a nozzle plate of a droplet ejection head includes a first step and second step. The first step is forming a first hole that communicates with a first face of a single-crystal silicon substrate whose surface crystal orientation is a {1 0 0} face, the first hole being longer in a [1 0 0] direction than in a [0 1 0] direction, and a second hole that is communicable with the first hole and a second face of the single-crystal silicon substrate. The second step is forming a nozzle channel including a nozzle tapered portion having a {1 1 1} face and a straight communicating portion continuous with the nozzle tapered portion by enlarging the first hole and the second hole by anisotropic wet etching on the single-crystal silicon substrate.

### TECHNICAL FIELD

The present invention relates to a method for manufacturing a nozzle plate.

### BACKGROUND ART

Conventionally, as described in PTL 1, it has been known to manufacture a nozzle plate of a droplet ejection head of a droplet ejection apparatus from a single-crystal silicon substrate. In the nozzle plate, a nozzle channel is formed by anisotropic wet etching.

### CITATION LIST

### Patent Literature

Patent Literature 1: Japanese Patent No. 5519263

### SUMMARY OF INVENTION

### Technical Problem

Incidentally, in a case where anisotropic wet etching is performed on a single-crystal silicon substrate whose surface crystal orientation is a {1 0 0} face, a corrosive action progresses in a certain direction. Therefore, it is possible to form only a nozzle channel in which the opening of the face facing the droplet ejection face is square. When such a nozzle plate is joined to another plate in which the sectional shape of an ink channel is, for example, rectangular, the shapes of the joined portions of the ink channel and the nozzle channel do not match. Therefore, the resistance at the time of ink ejection increases, and it is necessary to increase the drive voltage. In addition, the meniscus becomes unstable and ejection failure occurs, and thus the ejection characteristics deteriorate. Furthermore, since the shape of the nozzle channel is limited, it is difficult to increase the density of the nozzle openings arranged in a line in the single-crystal silicon substrate in order to ensure the volume of the nozzle channel.

In order to solve such a problem, an object of the present invention is to provide a method for manufacturing a nozzle plate that can achieve both an increase in density of nozzle openings and suitable ejection characteristics.

### Solution to Problem

The invention described in claim 1 is a method for manufacturing a nozzle plate of a droplet ejection head, including:
a first step of forming a first hole that communicates with a first face of a single-crystal silicon substrate whose surface crystal orientation is a {1 0 0} face, the first hole being longer in a [1 0 0] direction than in a [0 1 0] direction, and a second hole that is communicable with the first hole and a second face of the single-crystal silicon substrate; and
a second step of forming a nozzle channel including a nozzle tapered portion having a {1 1 1} face and a straight communicating portion continuous with the nozzle tapered portion by enlarging the first hole and the second hole by anisotropic wet etching on the single-crystal silicon substrate.

The invention described in claim 2 is the method for manufacturing a nozzle plate according to claim 1, wherein in the first step, the second hole is formed such that a length in a [0 0 1] direction is substantially equal to a length from an end of the second hole on a first face side where the first face is provided to an end of the first hole in the [1 0 0] direction.

The invention described in claim 3 is the method for manufacturing a nozzle plate according to claim 1,
wherein in the first step, the second hole is formed such that a length in a [0 0 1] direction is longer than a length from an end of the second hole on a first face side where the first face is provided to an end of the first hole in the [1 0 0] direction, and
wherein a step face is formed on the nozzle tapered portion.

The invention described in claim 4 is the method for manufacturing a nozzle plate according to any one of claims 1 to 3, wherein centers of the first hole and the second hole coincide with one another.

The invention described in claim 5 is the method for manufacturing a nozzle plate according to any one of claims 1 to 3, wherein in the first step, a bottom portion of the first hole is formed stepwise.

The invention described in claim 6 is the method for manufacturing a nozzle plate according to any one of claims 1 to 3,
wherein the first step includes:
   forming a third hole by deep-drilling the single-crystal silicon substrate partway from the first face by dry etching;
   subsequently forming a nozzle mask layer along an inner face of the third hole; and
   subsequently removing the nozzle mask layer formed on a bottom portion of the third hole,
wherein the first hole is formed by further deep-drilling the third hole, and
wherein in the second step, the nozzle channel including a nozzle straight portion continuous from an end of the nozzle tapered portion on a second face side where the second face is provided is formed.

The invention described in claim 7 is the method for manufacturing a nozzle plate according to any one of claims 1 to 3, wherein in the single-crystal silicon substrate, a non-wet etching layer is formed from the second face.

The invention described in claim 8 is the method for manufacturing a nozzle plate according to any one of claims 1 to 3, further including a third step of enlarging a diameter of an opening of the nozzle channel on a first face side where the first face is provided and/or a second face side where the second face side is provided.

### Advantageous Effects of Invention

According to the present invention, it is possible to provide a method for manufacturing a nozzle plate that can achieve both an increase in density of nozzle openings and suitable ejection characteristics.

### BRIEF DESCRIPTION OF DRAWINGS

FIG. 1 This is a perspective view of a droplet ejection apparatus in which droplet ejection heads each formed by a nozzle plate being stacked thereon is mounted.

FIG. 2A This is a plan view of the nozzle plate as viewed from the [0 0 1] direction.

FIG. 2B This is a plan view of the nozzle plate as viewed from the [0 0-1] direction.

FIG. 3 This is a sectional view of the nozzle plate according to a first embodiment as viewed from the [0 1 0] direction.

FIG. 4 This is a perspective sectional view illustrating a nozzle channel formed by the method for manufacturing a nozzle plate according to the first embodiment.

FIG. 5 This is sectional views illustrating the method for manufacturing a nozzle plate according to the first embodiment as viewed from the [0 1 0] direction and plan views illustrating the method as viewed from the [0 0 1] direction.

FIG. 6A This is a sectional view showing the progress of etching in Step 2 as viewed from the [1 0 0] direction.

FIG. 6B This is a sectional view showing the progress of etching in Step 2 as viewed from the [0 1 0] direction.

FIG. 7A This is a sectional view of the nozzle channel formed such that the centers of an opening hole and a nozzle hole are shifted in the [1 0 0] direction, as viewed from the [0 1 0] direction.

FIG. 7B This is a sectional view of the nozzle channel formed such that the length of the nozzle hole in the [0 0 1] direction is longer than the length from the end of the opening hole in the [1 0 0] direction to the end of the nozzle hole on the adhesive face side, as viewed from the [0 1 0] direction.

FIG. 7C This is a sectional view of the nozzle channel formed such that the length of the nozzle hole in the [0 0 1] direction is shorter than the length from the end of the opening hole in the [1 0 0] direction to the end of the nozzle hole on the adhesive face side, as viewed from the [0 1 0] direction.

FIG. 8 This is sectional views illustrating the method for manufacturing a nozzle plate according to a second embodiment as viewed from the [0 1 0] direction and plan views illustrating the method as viewed from the [0 0 1] direction.

FIG. 9A This is a sectional view of the nozzle plate according to a third embodiment as viewed from the [0 1 0] direction.

FIG. 9B This is a sectional view of the nozzle plate according to a modification example of the third embodiment as viewed from the [0 1 0] direction.

FIG. 10 This is a perspective sectional view of the nozzle channel formed by the method for manufacturing a nozzle plate according to the third embodiment.

FIG. 11 This is sectional views illustrating the method for manufacturing a nozzle plate according to the third embodiment as viewed from the [0 1 0] direction and plan views illustrating the method as viewed from the [0 0 1] direction.

FIG. 12A This is a sectional view of one nozzle channel and an intermediate structure serving as the nozzle channel according to Example 1 as viewed from the [0 1 0] direction.

FIG. 12B This is a plan view of the nozzle channel and the intermediate structure serving as the nozzle channel according to Example 1 as viewed from the [0 0 1] direction.

FIG. 13A This is a sectional view of one nozzle channel and an intermediate structure serving as the nozzle channel according to Example 2 as viewed from the [0 1 0] direction.

FIG. 13B This is a plan view of the nozzle channel and the intermediate structure serving as the nozzle channel according to Example 2 as viewed from the [0 0 1] direction.

FIG. 14A This is a sectional view of one nozzle channel and an intermediate structure serving as the nozzle channel according to Example 3 as viewed from the [0 1 0] direction.

FIG. 14B This is a plan view of the nozzle channel and the intermediate structure serving as the nozzle channel according to Example 3 as viewed from the [0 0 1] direction.

### DESCRIPTION OF EMBODIMENT

Hereinafter, preferred embodiments of the present invention will be described with reference to the drawings. However, the scope of the invention is not limited to the illustrated examples. In the following description, components having the same function and configuration are denoted by the same reference signs, and descriptions thereof are omitted.

In addition, Miller indices, which describe crystal faces and directions, are generally defined as follows, and the present specification also complies with these.
(h k 1): specific face
[h k 1]: equivalent face
[h k 1]: specific direction
<h k 1>: equivalent direction

In addition, unless otherwise specified, in Examples in the present specification, the following are used.
Face on adhesive side of wafer face: (0 0 1) face
Face on ejection side of wafer face: face (0 0 −1) face

Four tapered faces among faces constituting nozzle tapered portion: (1 1 1) face, (−1 1 1) face, (1 −1 1) face, and (−1 −1 1) face Vertical faces among faces constituting nozzle tapered portion and two opposed faces having longer sides among four lateral faces constituting straight communicating portion: (0 1 0) face and (0 −1 0) face

Two opposed faces having shorter sides among four lateral faces constituting straight communicating portion: (1 0 0) face and (−1 0 0) face

However, as a matter of course, as long as faces and directions are equivalent to the above contents, they are not limited to the above.

In addition, in the notation of Miller indices, as in (1) and (2) of the following Formula 1, a sign representing a negative index generally has a bar over the index. However, in the present specification, for convenience, it is expressed as in the following (1′) and (2′).

[Formula 1]

(hk̅l) (1)

[hk̅l] (2)

(h-k l) (1′)

[h-k l] (2′)

### First Embodiment

A method for manufacturing a nozzle plate 110 according to a first embodiment of the present invention will be described.

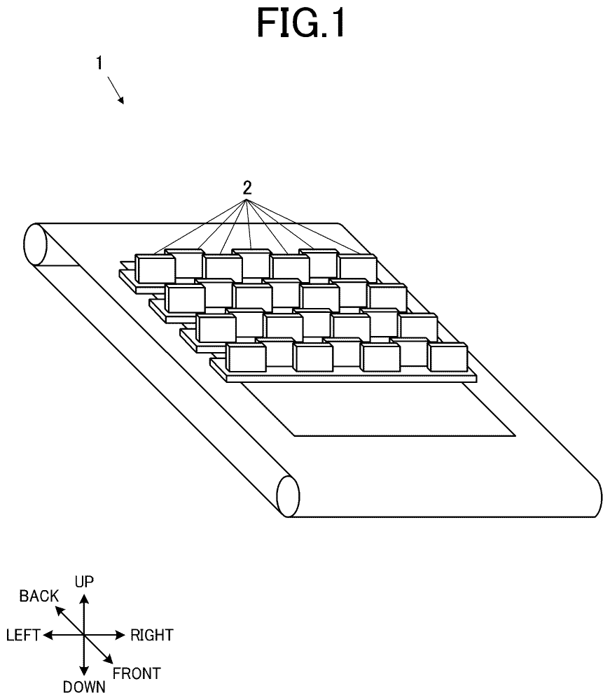

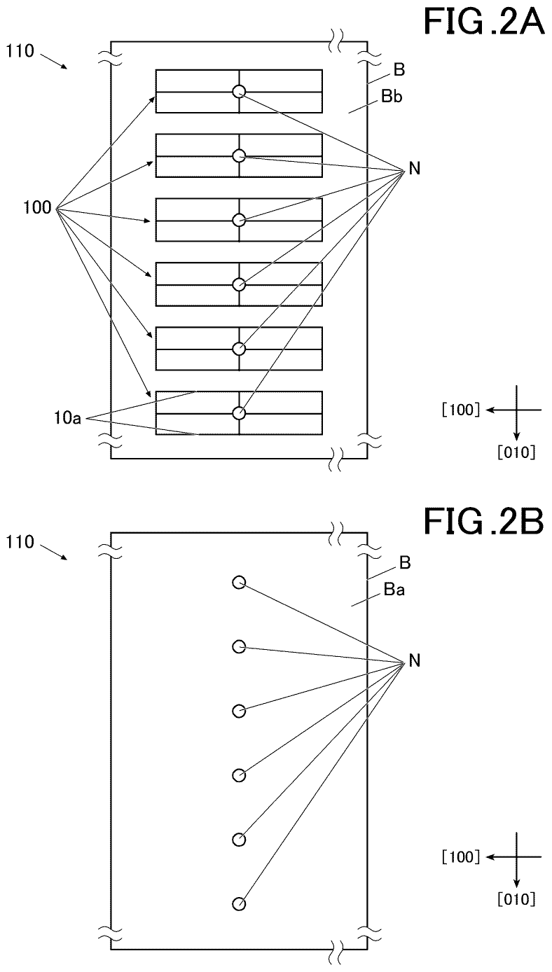

The method for manufacturing the nozzle plate 110 according to the first embodiment is the method for manufacturing the nozzle plate 110 (illustrated in FIG. 2) of a droplet ejection head 2 to be attached to a droplet ejection apparatus 1 as illustrated in FIG. 1.

(Nozzle Plate) The nozzle plate 110 is formed of a single-crystal silicon substrate B whose surface crystal orientation is the {1 0 0} face. FIG. 2A is a plan view illustrating the (0 0 −1) face of the nozzle plate 110, and FIG. 2B is a plan view illustrating the (0 0 1) face of the nozzle plate 110.

As illustrated in FIG. 2B, the nozzle plate 110 is provided with a plurality of nozzle openings N in an ejection face (second face) Ba((0 0 −1) face) so as to form a line along the [0 1 0] direction.

The nozzle plate 110 is provided with a plurality of nozzle channels 100 that penetrate from the adhesive face (first face) Bb((0 0 1) face) to the ejection face Ba.

To the adhesive face Bb of the nozzle plate 110, another plate including an ink channel is joined with an adhesive or the like. Liquid flowing in from the ink channel is ejected from the nozzle openings N via the nozzle channels 100.

Although FIG. 2B shows only one line of nozzle openings N, a plurality of lines of nozzle openings N may be arranged in the [1 0 0] direction.

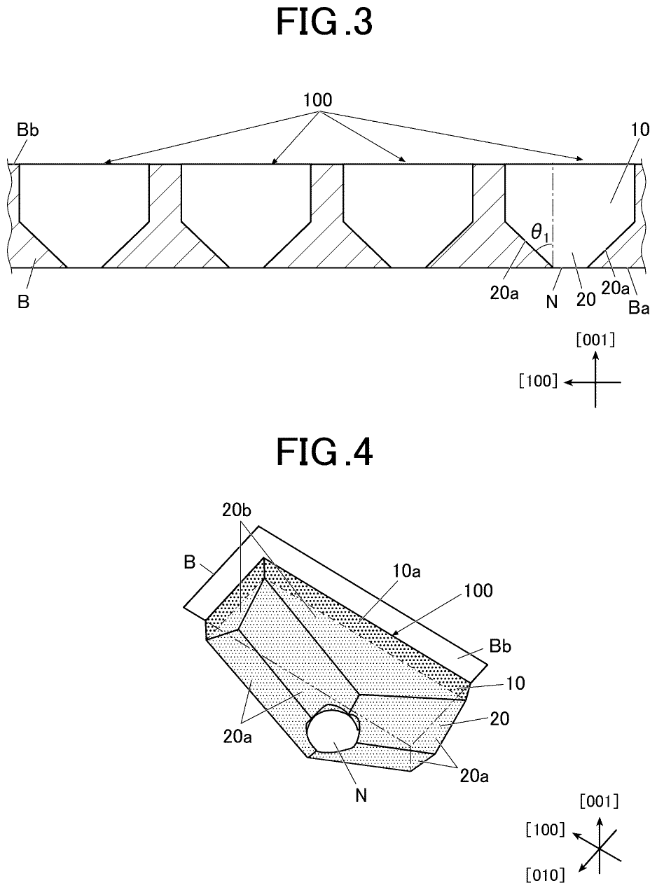

FIG. 3 is a sectional view of the nozzle plate 110 as viewed from the [0 1 0] direction. FIG. 4 is a perspective sectional view of one nozzle channel 100.

As illustrated in FIG. 3 and FIG. 4, each nozzle channel 100 includes a straight communicating portion 10, a nozzle tapered portion 20 and a nozzle opening N in order from the adhesive face Bb.

### {Straight Communicating Portion}

The straight communicating portion 10 is provided from the adhesive face Bb to an end of the nozzle tapered portion 20 on the adhesive face Bb side. That is, the straight communicating portion 10 constitutes an opening of the nozzle channel 100 on the adhesive face Bb side.

The straight communicating portion 10 is configured by part of four faces the crystal faces of which are the {1 0 0} face ((1 0 0) face, (−1 0 0) face, (0 1 0) face and (0 −1 0) face). In the straight communicating portion 10, as illustrated in FIG. 2A and FIG. 4, opposed faces 10a, which are a pair of faces, are substantially parallel to one another.

As illustrated in FIG. 2A and FIG. 4, among sides of a face(s) forming the straight communicating portion 10, the sides intersecting with the adhesive face Bb, the length in the [1 0 0] direction along the pair of opposed faces 10a is longer than the length in the [0 1 0] direction.

That is, the sides formed by the face constituting the straight communicating portion 10 and the face constituting the adhesive face Bb form an elongated shape as illustrated in FIG. 2A and FIG. 4. By forming the straight communicating portion 10 in this manner, it is possible to arrange the nozzle openings N at a narrow pitch of the short side length of the elongated shape while securing the volume of the nozzle channel 100. That is, the density of the nozzle openings N in the nozzle plate 110 can be increased.

FIG. 2A and FIG. 4 shows the case where the opening of the nozzle channel 100 on the adhesive face Bb side in the nozzle plate 110 is rectangular, but not limited thereto. If the opening of the nozzle channel 100 on the adhesive face side Bb is enlarged by performing Step 3 (third step, removal processing) described later, the opening always has a rectangular shape. However, in the present invention, Step 3 is not an essential step. Therefore, the opening of the nozzle channel 100 on the adhesive face Bb side in the nozzle plate 110 may have any shape corresponding to the shape of an opening pattern 303 described later as long as it has an elongated shape.

### {Nozzle Tapered Portion}

The nozzle tapered portion 20 includes a tapered face 20a having a substantially constant angle at which the channel area gradually increases from the ejection face Ba toward the adhesive face Bb. To be more specific, the nozzle tapered portion 20 is configured by the tapered face 20a of four faces the crystal faces of which are the {1 1 1} face ((1 1 1) face, (−1 1 1) face, (1 1 1) face and (−1 −1 1) face), and by 20b of part of the abovementioned four faces the crystal faces of which are the {1 0 0} face.

Note that the “channel area” in the present invention refers to a sectional area in a direction perpendicular to the ink ejection direction.

The tapered face 20a of the nozzle tapered portion 20 has an angle θ₁ (illustrated in FIG. 3) formed with an axis parallel to the nozzle central axis of 15° or more. In the present invention, the tapered face 20a is formed by performing anisotropic wet etching on the single-crystal silicon substrate B. Therefore, the angle θ₁ is 45° due to the etching characteristics of Si.

Providing the nozzle tapered portion 20 can stabilize the meniscus shape and droplet ejection even when the meniscus of liquid has retracted to the interior of the nozzle channel 100 due to high-speed driving.

### {Nozzle Opening}

The nozzle openings N are circular, elliptical, or polygonal holes that are provided in the ejection face Ba and from which droplets are ejected. Each nozzle opening N communicates with an end of the nozzle tapered portion 20 on the ejection face Ba side.

### (Method for Manufacturing Nozzle Plate)

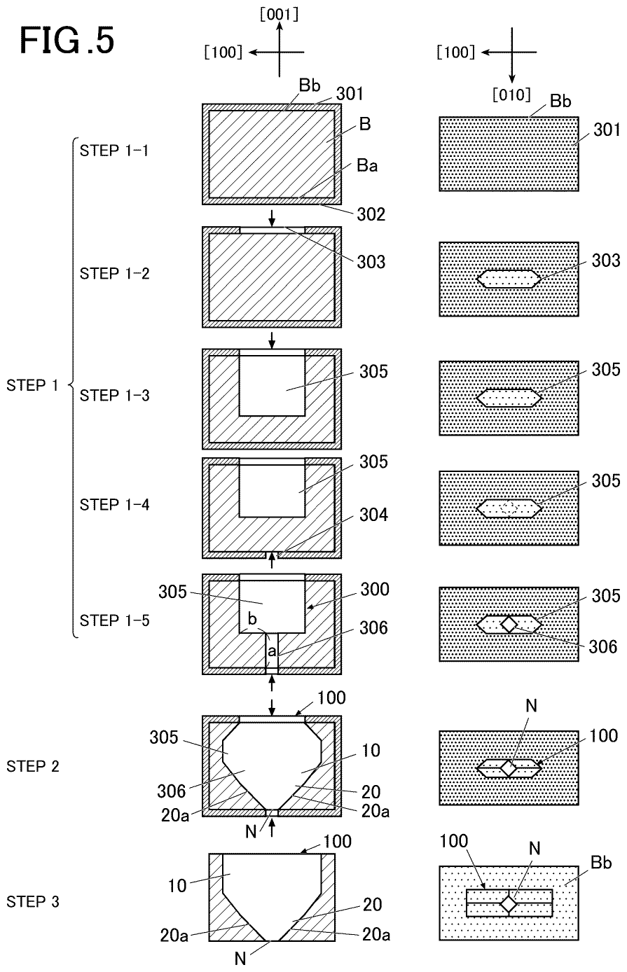

The method for manufacturing the nozzle plate 110 includes, for example, Steps 1 to 3 illustrated in FIG. 5.

In Step 1 (first step), an intermediate structure 300 including an opening hole (first hole) 305 and a nozzle hole (second hole) 306, which will be described later, is formed. In Step 2 (second step), anisotropic wet etching is performed on the intermediate structure 300 formed in Step 1, thereby forming the nozzle channel 100. In Step 3, removal processing is performed on the nozzle plate 110 formed in Step 2 as appropriate.

### {Step 1: Intermediate Structure Forming Step}

### (Step 1-1)

As illustrated in FIG. 5, Step 1 is divided into multiple steps.

First, as Step 1-1, a mask layer is formed on the surface of the single-crystal silicon substrate B. Specifically, a front face mask layer 301 is formed on the adhesive face Bb of the single-crystal silicon whose surface crystal orientation is the {1 0 0} face. Also, a back face mask layer 302 is formed on the ejection face Ba.

Hereinafter, when the front face mask layer 301 and the back face mask layer 302 are not particularly distinguished from one another, they are collectively referred to as the “mask layer” as described above.

The single-crystal silicon substrate B is a plate member having a thickness of about 100 μm to 725 μm. By using single-crystal silicon as the base material of the nozzle plate 110, high-precision processing is achieved. As a result, it is possible to form the nozzle plate 110 with little error in position and little variation in shape.

As the material for forming the mask layer, any material can be used as long as it can stop the progress of etching in anisotropic wet etching described below. Also, any material can be used as long as it is not removed by etching.

As long as these conditions are satisfied, the material of the mask layer is not particularly limited. For example, oxide such as SiO₂ can be used for the mask layer. A metal film of aluminum (Al), chromium (Cr), or the like, resin, or the like can be used for the mask layer.

In the present invention, SiO₂ is used as the mask layer.

The thickness of the mask layer is not particularly limited, but is preferably 0.1 μm to 50 μm, and especially preferably 0.5 μm to 20 μm. When the thickness of the mask layer is 0.5 μm or more, the etching stop effect is enhanced. When the thickness of the mask layer is 20 μm or less, the mask layer can be easily formed.

However, when the mask layer is formed by thermal oxidation described above, the thickness of the mask layer is preferably 1 μm to 5 μm. The mask layer is not limited to having a single-layer configuration as illustrated, and may have a multilayer configuration.

### (Step 1-2)

Next, as Step 1-2, in the front face mask layer 301, an elongated opening pattern 303 to be an opening of the nozzle channel 100 on the adhesive face Bb side is formed.

In the present embodiment, the shape of the opening pattern 303 is a hexagonal shape having long sides along the <1 0 0> direction, but not limited thereto. The shape of the opening pattern 303 may be any elongated shape that is longer in the [1 0 0] direction than in the [0 1 0] direction. Therefore, the shape of the opening pattern 303 may be, for example, a rectangular shape, an elliptical shape, or a shape in which each short side of a rectangle is combined with a semicircle having a diameter equal to the short side.

Specifically, first, a resist pattern is formed on the front face mask layer 301 by a known photolithography technique.

### <Resist Pattern>

For formation of the resist pattern, a positive photoresist or a negative photoresist can be used. For the positive photoresist and the negative photoresist, known materials can be used. For example, ZPN-1150-90 manufactured by Zeon Corporation can be used for the negative photoresist. For the positive photoresist, OFPR-800 LB or OEBR-CAP112PM manufactured by Tokyo Ohka Kogyo Co., Ltd. can be used.

A resist layer is formed by application to be a predetermined thickness using a spin coater or the like. After that, a pre-baking process is performed under conditions of, for example, 110° C. and 90 seconds.

To improve adhesiveness, HMDS treatment may be performed before resist application. For the HMDS treatment, an organic material called hexamethyldisilazane, for example, hexamethyldisilazane (OAP) (manufactured by Tokyo Ohka Kogyo Co., Ltd) or the like, can be used. The HMDS may be applied by a spin coater similarly to the resist application. An effect of adhesiveness improvement can be expected from the HMDS even in the case of exposure to hexamethyldisilazane vapor.

After formation of the resist layer, the resist layer is exposed with an aligner or the like using a predetermined mask. For example, in the case of a contact aligner, exposure is performed with a light amount of about 50 mJ/cm². Thereafter, the exposed portion of the resist layer is removed by immersion in a developer liquid (e.g., NMD-3 manufactured by Tokyo Ohka Kogyo Co., Ltd. for 60 seconds to 90 seconds). Thus, a resist pattern is formed on the front face mask layer 301.

After formation of the resist pattern, by using the resist pattern as a mask, the front face mask layer 301 is dry-etched, thereby forming an opening pattern 303. After formation of the opening pattern 303, the resist pattern is removed.

### <Dry Etching>

A reactive ion etching (RIE) apparatus is used for dry etching. A dry etching apparatus such as an inductively coupled plasma inductively coupled plasma (ICP)-RIE etching apparatus, which is a dry etching apparatus using an inductively coupled method as a discharge method, is used. As a process gas, CHF₃ (trifluoromethane), CF₄ (tetrafluoromethane), or the like is used.

As an example, RIE-100C, which is a dry etching apparatus manufactured by SAMCO INC., is used. The opening pattern 303 can be formed by etching for a predetermined time under the conditions that CHF₃ gas flow rate is 80 sccm, pressure is 3 Pa, and RF power is 90 W.

### <Removal of Resist Pattern>

Examples of the method for removing the resist pattern include a wet process using acetone or an acid solution and a dry process using oxygen plasma.

### (Step 1-3)

Next, as Step 1-3, the single-crystal silicon substrate B under the opening pattern 303 is subjected to a deep drilling process by dry etching to form an opening hole 305.

### (Step 1-4)

Next, as Step 1-4, a nozzle pattern 304 that becomes a nozzle opening N is formed.

The method for forming the nozzle patterns 304 is substantially the same as the method for forming the opening pattern 303 in Step 1-2. Note that the nozzle pattern 304 in the present embodiment has a square shape (rhombus shape) having sides in the <1 1 0> direction.

The nozzle pattern 304 is formed such that its center substantially coincides with the center of the opening pattern 303 when viewed from the adhesive face Bb or the ejection face Ba. Hereinafter, the aforementioned condition is referred to as “condition 1”.

### (Step 1-5)

Next, as Step 1-5, the single-crystal silicon substrate B under the nozzle pattern 304 is subjected to deep drilling by dry etching to form a nozzle hole 306.

The nozzle hole 306 is formed such that the length a thereof in the [0 0 1] direction substantially coincides with the length b from the end of the nozzle hole 306 on the adhesive face Bb side to the end of the opening hole 305 in the [1 0 0] direction. Hereinafter, the aforementioned condition is referred to as “condition 2”.

In Step 1-5, as illustrated in FIG. 5, the nozzle hole 306 is preferably formed so as to communicate with the opening hole 305. When the intermediate structure 300 in which the opening hole 305 and the nozzle hole 306 communicate with each other is formed at the time of Step 1, the fluidity of the solution for anisotropic wet etching used in Step 2 is improved. Therefore, anisotropic wet etching is always performed with fresh chemical liquid. In addition, hydrogen gas generated during anisotropic wet etching can be uniformly and efficiently removed from each of the nozzle channels 100. As a result, the progress of wet etching becomes uniform in the nozzle channels 100, and the nozzle channels 100 that are uniform can be formed.

However, it is not essential to form the intermediate structure 300 in which the opening hole 305 and the nozzle hole 306 communicate with each other at the time of Step 1. The opening hole 305 and the nozzle hole 306 may communicate with each other when the anisotropic wet etching is performed in Step 2.

In the above, Step 1 is performed in the order of Step 1-1, Step 1-2, Step 1-3, Step 1-4 and Step 1-5, but not limited thereto. It is sufficient to satisfy at least three conditions that Step 1-1 is performed first, Step 1-2 is performed before Step 1-3, and Step 1-4 is performed before Step 1-5.

Therefore, the condition 1 may be rephrased as “the opening pattern 303 is formed such that its center substantially coincides with the center of the nozzle pattern 304 when viewed from the adhesive face Bb or the ejection face Ba”.

In addition, the condition 2 may be rephrased as “the opening hole 305 is formed such that the length b from its end in the [1 0 0] direction to the end of the nozzle hole 306 on the adhesive face Bb side substantially coincides with the length a of the nozzle hole 306 in the [0 0 1] direction”.

### {Step 2: Anisotropic Wet Etching Step}

Next, as Step 2, anisotropic wet etching is performed on the intermediate structure 300 formed in Step 1 from both the adhesive face Bb side and the ejection face Ba side.

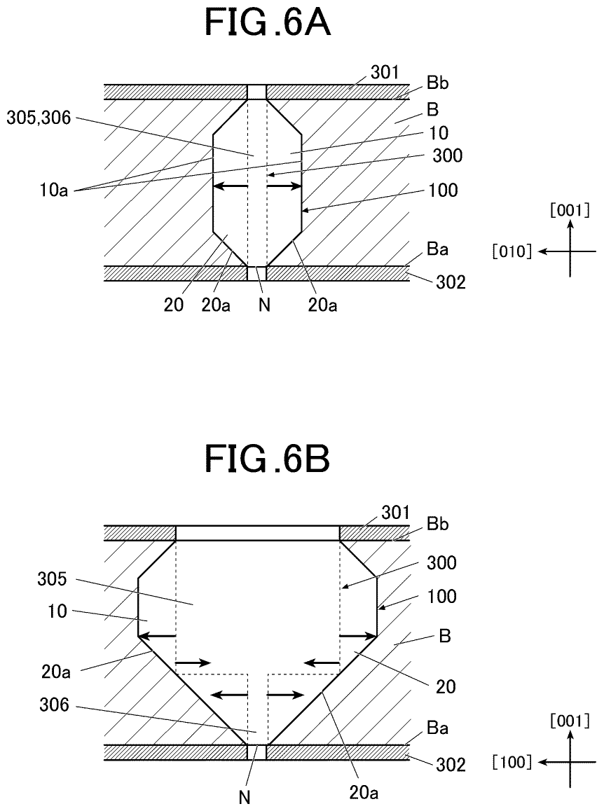

FIG. 6A is a sectional view showing the progress of etching in Step 2 as viewed from the [1 0 0] direction side, which is the short side of the opening hole 305. FIG. 6B is a sectional view showing the progress of etching in Step 2 as viewed from the [0 1 0] direction, which is the long side of the opening hole 305.

As illustrated in FIG. 6A and FIG. 6B, in Step 2, each of the opening hole 305 provided in Step 1-3 and the nozzle hole 306 provided in Step 1-5 is enlarged. Thus, the nozzle channel 100 including the nozzle tapered portion 20 and the straight communicating portion 10 is formed.

### <Anisotropic Wet Etching>

An alkaline aqueous solution is used for anisotropic wet etching. Specific examples thereof include potassium hydroxide (KOH), tetramethylammonium hydroxide (TMAH), and ethylenediamine pyrocatechol (EDP).

In Step 2, as illustrated in FIG. 6A, when viewed from the [1 0 0] direction, etching progresses in the [0 1 0] direction and the [0−1 0] direction with respect to the respective faces forming the opening hole 305 and the nozzle hole 306.

Therefore, the interval between the (0 1 0) face and the (0 −1 0) face after anisotropic wet etching is as follows: (Diameter of Nozzle Pattern 304+2×Amount of Etching) μm—(3).

As illustrated in FIG. 6B, when viewed from the [0 1 0] direction, etching progresses in the [1 0 0] direction and the [−1 0 0] direction with respect to the respective faces constituting the opening hole 305. In addition, etching progresses in the [1 0 0] direction or the [−1 0 0] direction with respect to the respective faces constituting the nozzle hole 306.

Therefore, the interval between the (1 0 0) face and the (−1 0 0) face after anisotropic wet etching is as follows: (Diameter of Nozzle Pattern 304+6×Amount of Etching) μm—(4).

In this embodiment, specifically, the diameter of the nozzle pattern 304 is 10 μm, and the amount of etching is 20 μm. Then, the interval between the (0 1 0) face and the (0 −1 0) face after anisotropic wet etching is 10 μm+2×20 μm=50 μm according to the above formula (3).

In addition, the interval between the (1 0 0) face and the (−1 0 0) face after anisotropic wet etching is 10 μm+6×20 μm=130 μm according to the above formula (4).

Meanwhile, the diameter of the nozzle pattern 304 is 30 μm, and the interval between the (0 1 0) face and the (0 −1 0) face after anisotropic wet etching is 50 μm. Then, according to the above formula (3), 30 μm+2×μm =50 μm, and the amount of etching x is 10 μm.

Then, the interval between the (1 0 0) face and the (−1 0 0) face after anisotropic wet etching is 30 μm+6× 10 μm=90 μm according to the above formula (4).

As described above, in the nozzle channel 100 formed in the present invention, the opening on the adhesive face Bb side preferably has an elongated shape in which a difference is provided between the dimension on the long side and the dimension on the short side, from the viewpoint of increasing the density of the nozzle openings N.

As described later, in a case where removal processing is performed such that the straight communicating portion 10 becomes substantially vertical as Step 3 after Step 2, the interval between the (0 1 0) face and the (0 −1 0) face becomes the dimension on the short side of the opening on the adhesive face Bb side of the nozzle channel 100. In addition, the interval between the (1 0 0) face and the (−1 0 0) face is the dimension on the long side.

Therefore, from the above calculation, it is preferable that the diameter of the nozzle pattern 304 is formed as small as possible.

However, in the present embodiment, the theoretical limit value of the ratio of the interval between the (0 1 0) face and the (0 −1 0) face to the interval between the (1 0 0) face and the (−1 0 0) face, that is, the ratio of the dimension on the short side to the dimension on the long side in the opening of the nozzle channel 100 on the adhesive face Bb side after Step 3 is 1:3.

### {Step 3: Removal Processing Step}

Returning to FIG. 5, after Step 2, as Step 3, removal processing such as etching, grinding, or polishing is performed on the nozzle plate 110. Specifically, for example, removal processing is performed such that the straight communicating portion 10 becomes substantially vertical, and the diameter of the opening of the nozzle channel 100 on the adhesive face Bb side after anisotropic wet etching is enlarged. Alternatively, the thickness of the nozzle plate 110 is adjusted to be a desired dimension. Alternatively, the mask layer is removed.

In particular, even when the diameter of the nozzle pattern 304 is formed to be small as described above, the diameter of the nozzle opening N can be expanded by performing, again form the ejection face Ba side, photolithography technique, transfer to the back face mask layer 302, and removal processing such as etching.

Step 3 is not an essential step, and may be appropriately performed as necessary.

### [Technical Effects]

As described above, the method for manufacturing the nozzle plate 110 according to the first embodiment includes Step 1 of forming the intermediate structure 300 including the opening hole (first hole) 305 long in the [1 0 0] direction and the nozzle hole (second hole) 306 communicable with the opening hole 305 and the ejection face Ba. The method further includes Step 2 of forming the nozzle channel 100 by enlarging the opening hole 305 and the nozzle hole 306 by anisotropic wet etching.

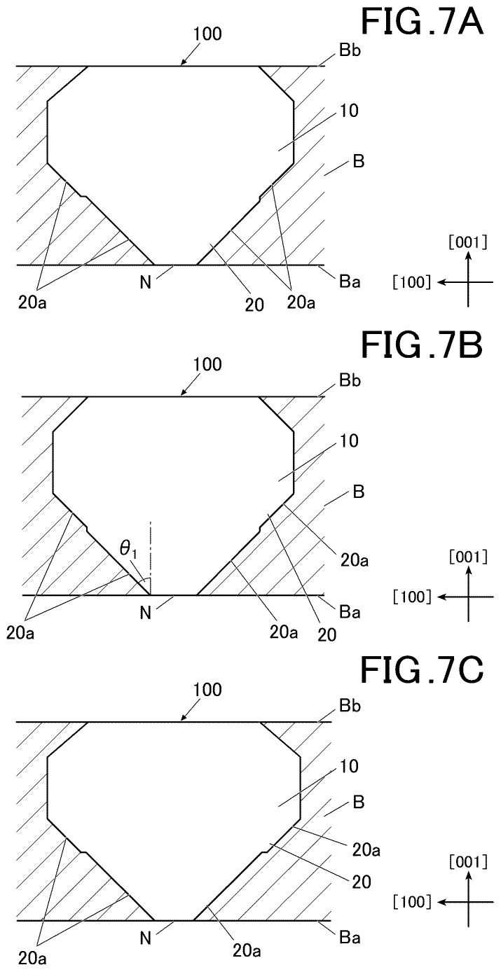

The reason why the “substantially coincides” is written in the condition 1 and the condition 2 above is that in each condition, they may not completely coincide with each other due to a manufacturing error. FIG. 7A illustrates a case where the condition 1 is not satisfied. FIG. 7B illustrates a case where a >b and the condition 2 is not satisfied. FIG. 7C illustrates a case where a<b and the condition 2 is not satisfied. In each of FIG. 7A to FIG. 7C, the tapered face 20a includes a step.

As understood from a comparison between FIG. 5 and FIG. 7A to FIG. 7C, the nozzle channel 100 having a smooth tapered face 20a is formed by satisfying the condition 1 and the condition 2.

Meanwhile, as illustrated in FIG. 7A to FIG. 7C, even when a manufacturing error related to the condition 1 or the condition 2 occurs in Step 1, the nozzle opening N is positioned at the center of symmetry of the face between the nozzle opening N and the tread in the tapered face 20a. This is because, of the nozzle tapered portion 20, at least a portion that communicates with the nozzle opening N is formed to be enlarged from the nozzle hole 306.

As described above, according to the above-described manufacturing method, even if there is a manufacturing error in relation to the condition 1 or the condition 2, the nozzle tapered portion 20 is always formed from the nozzle hole 306. Then, the nozzle opening N is arranged without displacement at the center of symmetry of the face between the nozzle opening N and the tread in the tapered face 20a. Therefore, even if there is a manufacturing error in relation to the condition 1 or the condition 2, it is possible to form the nozzle plate 110 including the nozzle channel 100 in which there is no eccentricity, the symmetry of the flow of the liquid is maintained, and the ejection angle is stable.

Furthermore, according to the manufacturing method described above, it is possible to form the nozzle plate 110 including the nozzle channel 100 whose opening in the adhesive face Bb has an elongated shape. Therefore, the density of the nozzle openings N can be increased in the nozzle plate 110. In addition, when the nozzle plate 110 is joined to another plate in which the sectional shape of the ink channel is an elongated shape, the shapes of the joined portions of the nozzle channel 100 and the ink channel coincide with each other, and thus favorable ejection characteristics are obtained.

### [Other Preferable Configurations]

As described above, the shape of the opening pattern 303 is not limited to the hexagonal shape having long sides along the <1 0 0> direction. The shape of the nozzle pattern 304 is also not limited to the square shape having sides along the <1 1 0> direction.

Provided that in consideration of crystal orientation dependency of anisotropic wet etching, it is particularly preferable that the opening pattern 303 and the nozzle pattern 304 have the above-described shapes. With the above shapes, anisotropic wet etching as illustrated in FIG. 5 tends to occur.

The cases where the manufacturing error related to the condition 1 or the condition 2 occur in Step 1 are exemplified from FIG. 7A to FIG. 7C. Among these, as illustrated in FIG. 7B, the nozzle channel 100 in which a>b is satisfied and a hanging face providing a step in the nozzle tapered portion 20 or an inclined face (step face) having an inclination steeper than the angle θ1 is formed has more excellent meniscus stability.

The reason is that, when the step face is formed, even if the meniscus returns to the deep side of the nozzle channel 100, the spread of the meniscus in the [1 0 0] direction is suppressed, and the width length in the [1 0 0] direction and the width length in the [0 1 0] direction can be aligned.

Note that the step face is preferably formed such that the length from the ejection face Ba to the end of the step face on the adhesive face Bb side is 20 μm or more and 60 μm or less.

This is because the pull-in of liquid is rarely greater than 20 μm. Also, this is because if the length is longer than 60 μm, the nozzle channel 100 cannot secure a sufficient volume.

### Second Embodiment

Next, the method for manufacturing the nozzle plate 110 according to a second embodiment will be described.

In the second embodiment, after formation of the opening pattern 303, a pattern having a different size and a different thickness is further formed to form the opening hole 305 stepwise at its bottom portion.

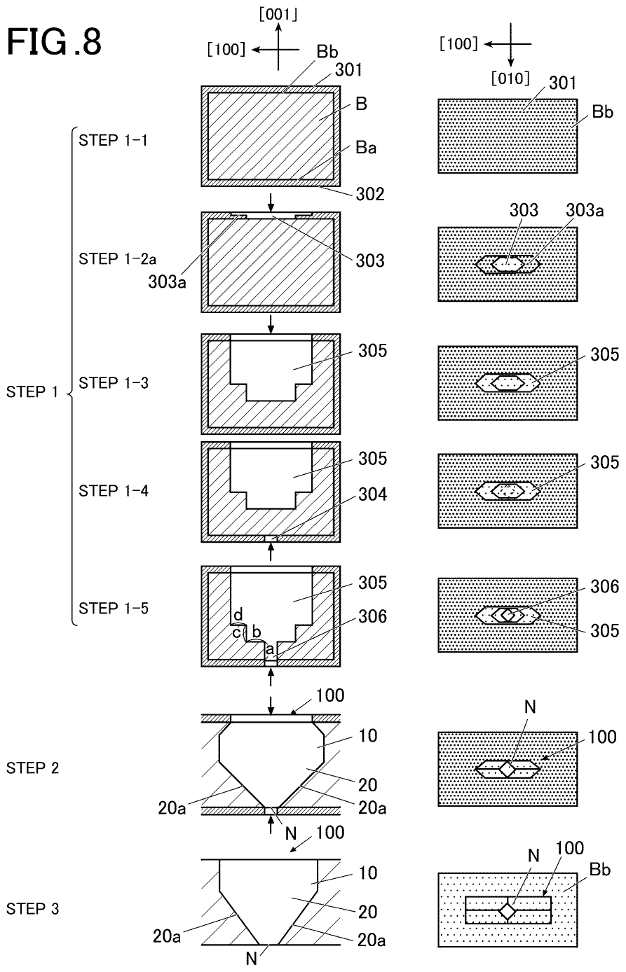

FIG. 8 illustrates the method for manufacturing the nozzle plate 110 according to the second embodiment. Note that Step 1-1 is the same as that in the first embodiment, and therefore, a detailed description thereof is omitted.

### (Step 1-2a)

In the present embodiment, formation of a resist pattern and dry etching are performed twice as Step 1-2a. Specifically, after formation of the opening pattern 303, a resist pattern having a size that surrounds the opening pattern 303 is formed. Dry etching is performed with an amount of etching smaller than that for the opening pattern 303 to form a sub-pattern 303a.

After the opening pattern 303 and the sub-pattern 303a are formed, the resist pattern is removed.

### (Step 1-3)

After formation of the opening pattern 303 and the sub-pattern 303a, the opening hole 305 is formed by performing deep drilling by dry etching.

At the time, in the sub-patterns 303a, the front face mask layer 301 is first etched. When etching of the front face mask layer 301 is completed, the single-crystal silicon substrate B is etched. On the other hand, there is no front face mask layer 301 in the opening pattern 303. Therefore, the single-crystal silicon substrate B is immediately etched.

Therefore, even if etching is performed for the same time, the amount of etching of the single-crystal silicon substrate B is different between the opening pattern 303 and the sub-pattern 303a. That is, the single-crystal silicon substrate B under the opening pattern 303 is etched deeper. As a result, as illustrated in FIG. 8, the opening hole 305 stepwise at the bottom portion is formed.

The step formed in Step 1-3 is preferably designed such that the length c in the [0 0 1] direction and the length d in the [1 0 0] direction satisfy a≈b≈d. Similarly to the first embodiment, when the abovementioned condition is satisfied, the nozzle channel 100 having a smooth tapered face 20a is formed.

### (Step 1-4, Step 1-5, Step 2 and Step 3)

After the opening hole 305 is formed, the nozzle hole 306 is formed in Step 1-4 and Step 1-5. Then, in Step 2, the nozzle channel 100 is formed by anisotropic wet etching.

After Step 2, removal processing is appropriately performed as Step 3.

### [Technical Effects]

As described above, in the method for manufacturing the nozzle plate 110 according to the second embodiment, the sub-pattern 303a having a size and a thickness different from those of the opening pattern 303 is formed, thereby forming the opening hole 305 stepwise at the bottom portion.

According to the above-described configuration, the ratio of the dimension on the short side to the dimension on the long side in the opening of the nozzle channel 100 on the adhesive face Bb side can be made larger than 1:3. Therefore, the density of the nozzle openings N can be further increased.

### Modification Example

In the above, the sub-pattern 303a is formed after the formation of the opening pattern 303, but not limited thereto, and the order may be reversed.

Furthermore, in the above, the formation of the resist pattern and the dry etching are performed twice, but not limited thereto. That is, the opening hole 305 having a plurality of steps may be formed by performing the formation of the resist pattern and the dry etching twice or more.

Furthermore, in the above, the formation of the resist pattern and the dry etching are performed multiple times, but not limited thereto. That is, the opening pattern 303 and the sub-pattern 303a may be formed at one time the use of a gray-tone mask.

### Third Embodiment

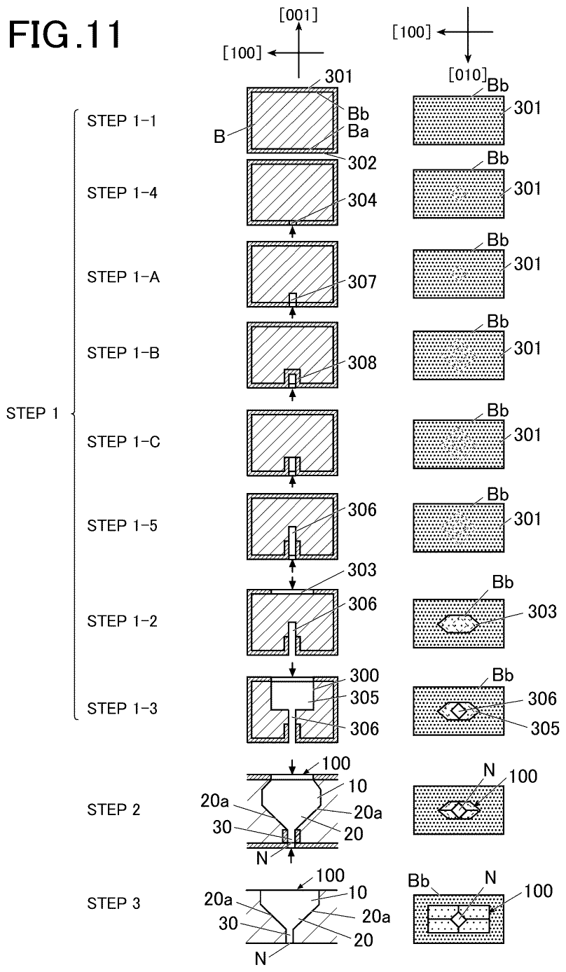

Next, the method for manufacturing the nozzle plate 110 according to a third embodiment will be described with reference to FIG. 11.

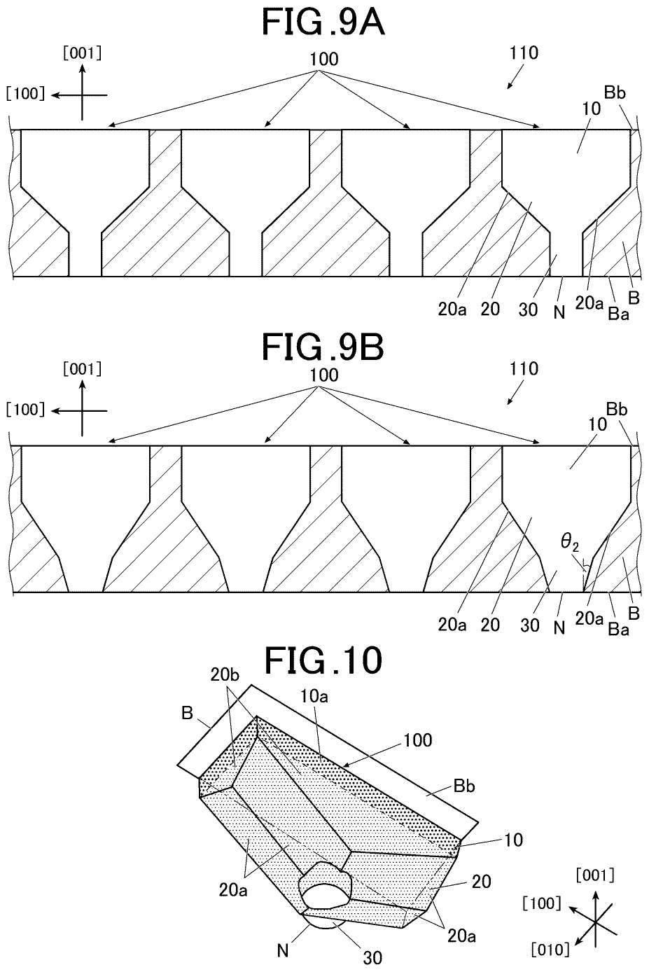

In the method for manufacturing the nozzle plate 110 according to the third embodiment, the nozzle channel 100 including a nozzle straight portion 30 as illustrated in FIG. 9 and FIG. 10 is formed.

### {Nozzle Straight Portion}

The nozzle straight portion 30 is a channel having the ejection face Ba side continuous with the nozzle opening N and the adhesive face Bb side continuous with the nozzle tapered portion 20.

Note that in the following, the nozzle straight portion 30 is constituted by a face having an angle of 0° with respect to an axis parallel to the nozzle central axis as illustrated in FIG. 9A, but not limited thereto.

For example, as illustrated in FIG. 9B, an angle θ2 formed by the face constituting the nozzle straight portion 30 and the axis parallel to the nozzle central axis is substantially uniform at any position and satisfies 0°≤θ₂<15°.

In the present embodiment, Step 1-A to Step 1-C are sequentially performed at least after Step 1-4 and before Step 1-5. In the present embodiment, the order of the steps is not particularly limited as long as three conditions that are the abovementioned condition, a condition that Step 1-1 is performed first, and a condition that Step 1-2 is performed before Step 1-3 are satisfied.

Provided that it is practically preferable to perform Step 1-A to Step 1-C before Step 1-3. This is because, when Step 1-B described below is performed after Step 1-3, a mask layer is formed in the opening hole 305 too, and a step of removing the mask layer is required.

Therefore, in the following, the steps are performed in the order of Step 1-1, Step 1-4, Step 1-A, Step 1-B, Step 1-C, Step 1-5, Step 1-2, Step 1-3, Step 2 and then Step 3.

Since Step 1-1 to Step 1-5 are the same as those in the first embodiment, detailed descriptions thereof are omitted.

### (Step 1-A)

After the nozzle pattern 304 is formed in Step 1-4, as Step 1-A, the single-crystal silicon substrate B under the nozzle pattern 304 is dry-etched by a predetermined amount. Thus, a nozzle straight hole (third hole) 307 is formed. In the above-described step, it is sufficient to perform etching by an amount corresponding to the planned length of the nozzle straight portion 30.

### (Step 1-B)

After the nozzle straight hole 307 is formed, as Step 1-B, a nozzle mask layer 308 is formed along the inner face of the nozzle straight hole 307. The method for forming the nozzle mask layer 308 is the same as the method for forming the mask layer with the same material.

### (Step 1-C)

After the nozzle mask layer 308 is formed, as Step 1-C, the nozzle mask layer 308 formed on the bottom portion of the nozzle straight hole 307 is removed. The nozzle mask layer 308 on the bottom portion of the nozzle straight hole 307 can be removed by dry etching using an RIE apparatus or the like. However, since dry etching by an RIE apparatus uses a vertical etchant, the nozzle mask layer 308 formed on the lateral face portion is more difficult to remove by dry etching than formed on the bottom portion. Therefore, of the nozzle mask layer 308, the one formed on the bottom portion of the nozzle straight hole 307 is etched first, and the one formed at the lateral face portion remains.

Note that, by setting the etching condition in the above-described step to a low pressure or a high bias, the nozzle mask layer 308 at the lateral face portion may be less likely to be etched.

### (Step 1-5, Step 1-2 and Step 1-3)

After Step 1-C, as Step 1-5, the single-crystal silicon substrate B is dry-etched, and the nozzle hole 306 is formed by further deep-drilling the nozzle straight hole 307. Then, the opening hole 305 is provided in Step 1-2 and Step 1-3.

### (Step 2 and Step 3)

Then, anisotropic wet etching is performed as Step 2. At the time, the lateral face portion of the nozzle straight hole 307 is protected by the nozzle mask layer 308. Therefore, the progress of etching at the lateral face portion of the nozzle straight hole 307 is suppressed, and the lateral face portion remains as the nozzle straight portion 30.

After Step 2, removal processing is appropriately performed as Step 3. Note that in Step 3 of the present embodiment, the nozzle mask layer 308 may be removed together with the mask layer.

### [Technical Effects]

As described above, the method for manufacturing the nozzle plate according to the third embodiment includes Step 1-A to Step 1-C of forming the nozzle straight hole 307 and the nozzle mask layer 308.

According to the above configuration, the nozzle channel 100 including the nozzle straight portion 30 can be formed. The nozzle straight portion 30 can increase the resistance at the time of droplet ejection to suppress the vibration of the meniscus and further stabilize the meniscus shape. Therefore, it is possible to form the nozzle plate 110 including the nozzle channel 100 with improved ejection stability.

### Modification Example

In the above, the nozzle straight portion 30 is formed by forming the nozzle straight hole 307 and the nozzle mask layer 308, but not limited thereto.

The nozzle straight portion 30 can be formed even by using a single-crystal silicon substrate B provided with a non-wet etching layer having etching resistance.

The non-wet etching layer refers to a layer having etching resistance, which can be formed by, for example, masking, thermal oxidation, or high-concentration B (boron) doping. Furthermore, a quartz layer formed by means other than the above-described thermal oxidation may be provided on the single-crystal silicon substrate B, and the quartz layer may be used as the non-wet etching layer.

Specifically, first, a non-wet etching layer having the same thickness as the nozzle plate 110 is provided on at least the ejection face Ba side of the single-crystal silicon substrate B. Then, when such a single-crystal silicon substrate B is used to form the nozzle hole 306 and anisotropic wet etching is performed, the non-wet etching layer plays a role equivalent to the nozzle mask layer 308.

Therefore, even when the single-crystal silicon substrate B including the non-wet etching layer is used, the nozzle straight portion 30 can be formed in the nozzle channel 100.

It is needless to say that the “length a of the nozzle hole 306 in the [0 0 1] direction” in relation to the condition 2 does not include the length of a portion having etching resistance, such as the nozzle mask layer 308 and the non-wet etching layer, in the [0 0 1] direction.

In the manufacturing process according to each embodiment, in order to use the nozzle plate 110 for a long period of time, a step of forming at least one protective film may be added.

In this case, after Step 2 or Step 3, a step of forming a protective film that covers at least part of the surface including the inside of the nozzle channel 100 is performed.

As the protective film, a material that is not dissolved mainly by contact with ink, for example, a metal oxide film (tantalum pentoxide, hafnium oxide, niobium oxide, titanium oxide, zirconium oxide, or the like), a metal silicate film (tantalum silicate, hafnium silicate, niobium silicate, titanium silicate, zirconium silicate, or the like) in which silicon is contained in a metal oxide film, a silicon carbide (SiC) film, a diamond-like carbon (DLC) film, or the material used for forming the mask layer can be selected and used. An organic film of polyimide, polyamide, or parylene may be used as the protective film.

The thickness of the protective film is not particularly limited, but may be, for example, 0.05 μm to 20 μm.

### EXAMPLES

Next, with respect to Examples and Comparative Example of the present invention, the results of evaluating preferred configurations will be described. Hereinafter, the present invention will be specifically described with reference to Examples, but the present invention is not limited thereto.

### [Preparation of Sample]

A nozzle plate 110 having 1,280 nozzle channels 100 formed as in each of the following Examples and Comparative Example was manufactured. Next, a piezoelectric plate having an ink channel in which the shape of the opening on the adhesive face is the same as the shape of the opening of the nozzle channel 100 on the adhesive face Bb side was joined to form an inkjet head as the droplet ejection head 2. Then, the inkjet head was mounted in an inkjet recording apparatus as the droplet ejection apparatus 1.

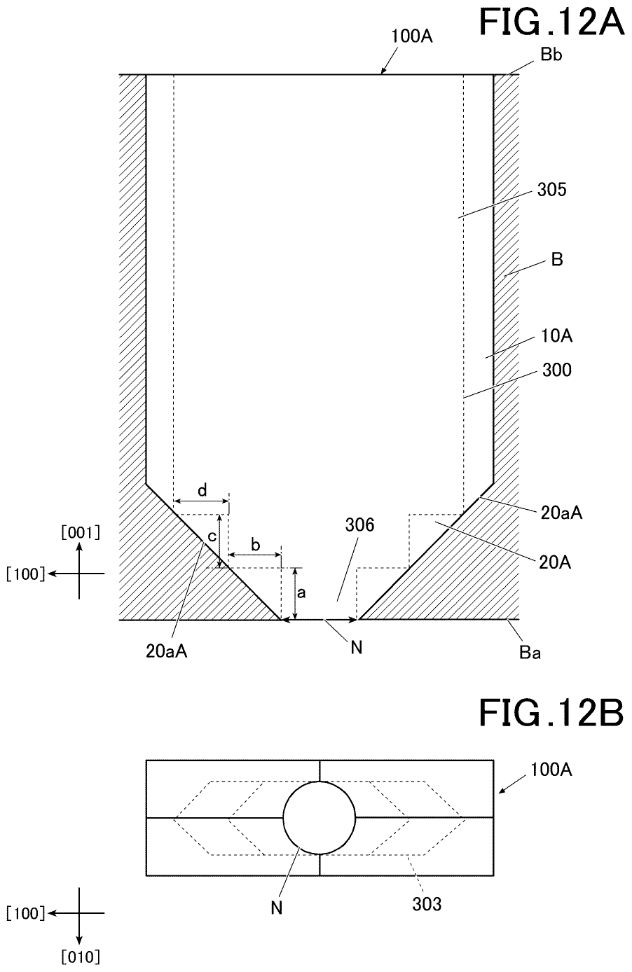

FIG. 12 to FIG. 14 each show one nozzle channel 100 in the nozzle plate 110 according to each Example. In each drawing, a dotted line portion indicates the intermediate structure 300 formed in Step 1. In addition, a solid line portion indicates the nozzle channel 100 in which the opening on the adhesive face Bb side is formed in a rectangular shape by performing the anisotropic wet etching on the intermediate structure 300 in Step 2 and performing the removal processing such that the straight communicating portion 10 becomes substantially vertical in Step 3.

### Example 1

A nozzle plate 110 was formed based on the manufacturing method according to the second embodiment. That is, as illustrated in FIG. 12A and FIG. 12B, an intermediate structure 300 in which the bottom portion of the opening hole 305 is stepwise was formed. Then, a nozzle channel 100A including a nozzle tapered portion 20A, a straight communicating portion 10A and a nozzle opening N was formed.

Note that as illustrated in FIG. 12B, the opening pattern 303 had a hexagonal shape in plan view. The dimension of the opening of the nozzle channel 100A on the adhesive face Bb side was 50 μm m ×130 μm, and the nozzle opening N had a circular shape with a diameter of 30 μm. The intermediate structure 300 formed in Step 1 was designed to satisfy a≈b≈c≈d.

### Example 2

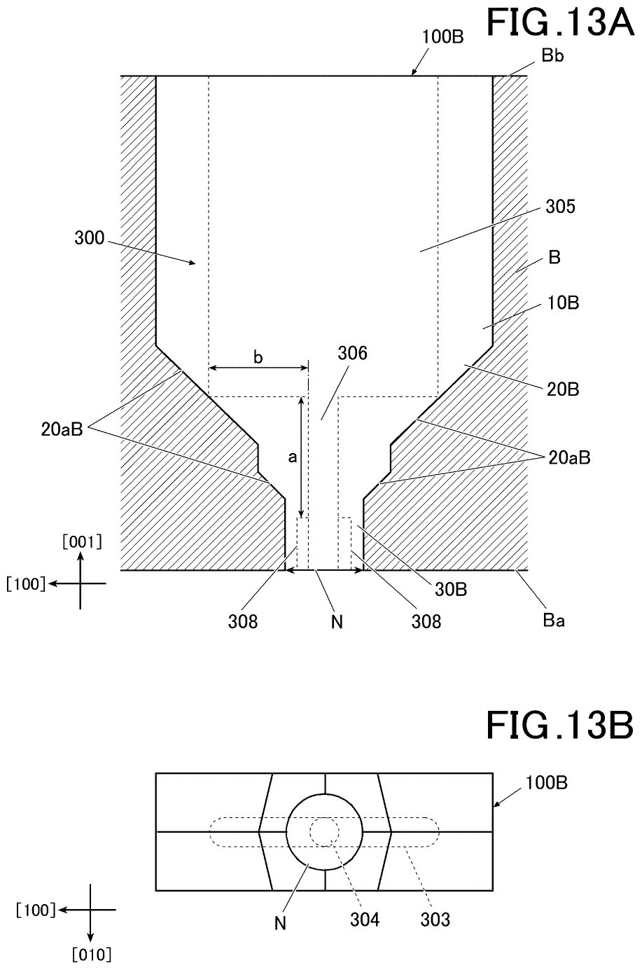

A nozzle plate 110 was formed based on the manufacturing method according to the third embodiment. That is, as illustrated in FIG. 13A and FIG. 13B, a nozzle channel 100B including a nozzle straight portion 30B, a nozzle tapered portion 20B, a straight communicating portion 10B and a nozzle opening N was formed.

As illustrated in FIG. 13B, the opening pattern 303 had a shape in which each short side of a rectangle was combined with a semicircle having a diameter equal to the short side. The dimension of the opening of the nozzle channel 100B on the adhesive face Bb side was 50 μm×130 μm. The length of the nozzle straight portion 30B in the [0 0 1] direction was 30 μm. As illustrated in FIG. 13A and FIG. 13B, in this example, a circular nozzle pattern 304 having a diameter of 10 μm was formed in Step 1-4, and the nozzle opening N was expanded to have a circular shape having a diameter of 30 μm in Step 3.

In addition, for the condition 2, it was designed so as to satisfy a >b. Therefore, a vertical face (step face) having a length of 10 μm in the [0 0 1] direction was formed to provide a step on the tapered face 20aB of the nozzle tapered portion 20B.

### Example 3

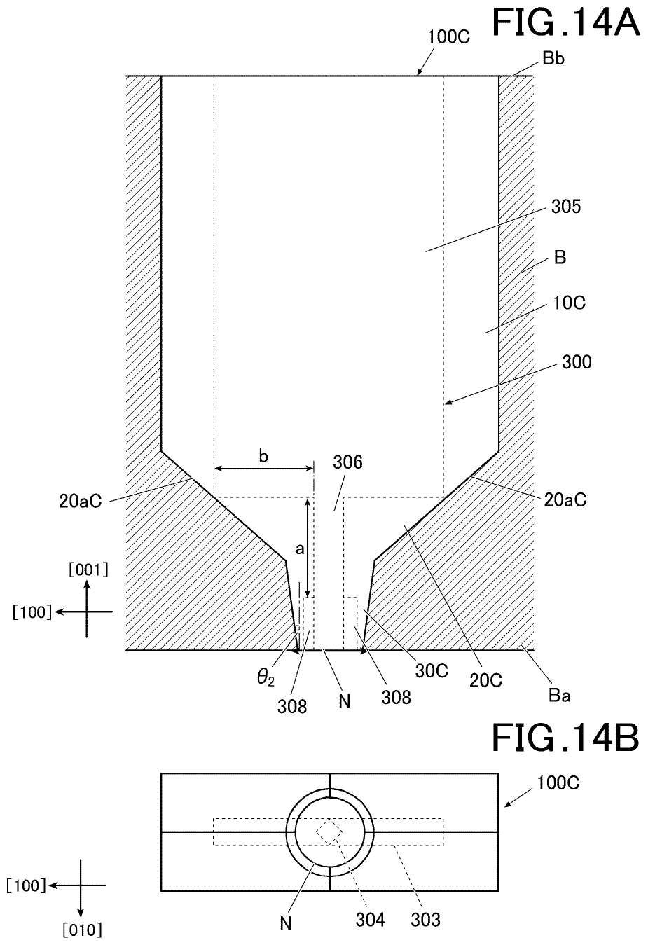

A nozzle plate 110 was formed based on the manufacturing method according to the third embodiment. That is, as illustrated in FIG. 14A and FIG. 14B, a nozzle channel 100C including a nozzle straight portion 30C, a nozzle tapered portion 20C, a straight communicating portion 10C and a nozzle opening N was formed.

As illustrated in FIG. 14B, the opening pattern 303 had a rectangular shape having a longer length in the [0 1 0] direction than in the [1 0 0] direction. The dimension of the opening of the nozzle channel 100C on the adhesive face Bb side was 50 μm×130 μm. As illustrated in FIG. 14A and FIG. 14B, in this example, a rhombic nozzle pattern 304 having a diameter of 10 μm was formed in Step 1-4, and the nozzle opening N was expanded to have a circular shape having a diameter of 30 μm in Step 3.

In addition, for the condition 2, it was designed so as to satisfy a=b. Therefore, no step face was formed on the tapered face 20aC of the nozzle tapered portion 20C.

For the nozzle straight portion 30C, etching conditions were appropriately set in the step of expanding the nozzle opening. Therefore, the nozzle straight portion 30C had a tapered face with an angle θ2 of 8°, and had a length in the [0 0 1] direction of 35 μm and a diameter at the end on the adhesive face Bb side of 40 μm.

### Comparative Example 1

A nozzle channel 100 was formed by a conventionally known method. That is, although a nozzle tapered portion 20 and a straight communicating portion 10 were provided, the opening of the nozzle channel 100 on the adhesive face Bb side had a square shape of 50 μm ×50 μm.

The following Test 1 and Test 2 were conducted using an inkjet recording apparatus in which an inkjet head(s) including the nozzle plate 110 of Example 1, 2 or 3 or Comparative Example 1 described above was mounted.

### [Test 1. Ejection Angle Test]

UV ink heated to have a viscosity of 8 cP was ejected at a drive voltage at which the average droplet speed was about 6 m/s. At the time, whether the ejection angle, which is an angle formed by the nozzle central axis and the ejection liquid, was within #what degree(s) was evaluated about 1,280 nozzles.

### [Test 2. Upper Limit Speed Test]

At a drive frequency of 40 kHz, the ejection speed of the UV ink heated to have a viscosity of 8 cP was increased from 5 m/s. Then, the ejection speed at which five or more nozzles out of 100 nozzles had the nozzle opening N with ejection failure was measured. Note that in a case where the ejection speed is equal to or higher than 9 m/s, although the ejection speed is high, ejection failure is less likely to occur. When the ejection speed is 11 m/s, the ejection failure is less likely to occur, which is preferable. Therefore, as the meniscus stability, evaluations were made as follows: “C” for less than 9 m/s, “B” for 9 m/s or more and less than 11 m/s, and “A” for 11 m/s or more.

The results of Test 1 and Test 2 are shown in TABLE I.

TABLE 1

| | | | | COMPAR- |
|---|---|---|---|---|
| | | | | ATIVE |
| | EXAM- | EXAM- | EXAM- | EXAMPLE |
| | PLE 1 | PLE 2 | PLE 3 | 1 |
| SHAPE [μm] OF | 50 × 130 | 50 × 130 | 50 × 130 | 50 × 50 |
| OPENING OF | | | | |
| NOZZLE CHANNEL | | | | |
| ON ADHESIVE | | | | |
| FACE SIDE | | | | |
| DIAMETER [μm] OF | 30 | 30 | 30 | 30 |
| NOZZLE OPENING | | | | |
| PRESENCE/ | ABSENT | PRESENT | PRESENT | ABSENT |
| ABSENCE OF | | | | |
| NOZZLE STRAIGHT | | | | |
| PORTION | | | | |
| PRESENCE/ | ABSENT | PRESENT | ABSENT | ABSENT |
| ABSENCE OF STEP | | | | |
| ON TAPERED FACE | | | | |
| OF NOZZLE | | | | |
| TAPERED PORTION | | | | |
| DRIVE VOLTAGE | 23 | 25 | 24 | 30 |
| [V] AT 6 m/s | | | | |
| EJECTION ANGLE | 0.3 | 0.2 | 0.2 | 0.3 |
| [°] | | | | |
| MENISCUS | B | A | B | C |
| STABILITY [UPPER | (9) | (13) | (10) | (8) |
| LIMIT SPEED m/s] | | | | |

### [Evaluations]

When Example 1 is compared with Comparative Example 1, Example 1 was more excellent in meniscus stability and was less likely to cause ejection failure. This is because, in Example 1, the nozzle tapered portion 20A was formed such that the center of the nozzle opening N was positioned at the center of symmetry of the tapered face 20aA.

When Example 1 is compared with Examples 2 and 3, the ejection angle was improved and the ejection characteristics ware enhanced in Examples 2 and 3. This is because the nozzle straight portion 30B, 30C was formed in the nozzle channel 100.

When Example 2 is compared with Example 3, Example 2 was more excellent in meniscus stability and ejection failure was less likely to occur. This is because the step face was formed on the tapered face 20aB of the nozzle tapered portion 20B.

### INDUSTRIAL APPLICABILITY

The present invention is applicable to a method for manufacturing a nozzle plate that can achieve both an increase in density of nozzle openings and suitable ejection characteristics.

### REFERENCE SIGNS LIST

2 Droplet Ejection Head
10 Straight Communicating Portion
20 Nozzle Tapered Portion
30 Nozzle Straight Portion
100 Nozzle Channel
110 Nozzle Plate
305 Opening Hole (First Hole)
306 Nozzle Hole (Second Hole)
307 Nozzle Straight Hole (Third Hole)
308 Nozzle Mask Layer
N Nozzle Opening
B Single-crystal Silicon Substrate
Ba Ejection Face (Second Face)
Bb Adhesive Face (First Face)

1. A method for manufacturing a nozzle plate of a droplet ejection head, comprising:
a first step of forming a first hole that communicates with a first face of a single-crystal silicon substrate whose surface crystal orientation is a {1 0 0} face, the first hole being longer in a [1 0 0] direction than in a [0 1 0] direction, and a second hole that is communicable with the first hole and a second face of the single-crystal silicon substrate; and
a second step of forming a nozzle channel including a nozzle tapered portion having a {1 1 1} face and a straight communicating portion continuous with the nozzle tapered portion by enlarging the first hole and the second hole by anisotropic wet etching on the single-crystal silicon substrate.

2. The method for manufacturing a nozzle plate according to claim 1, wherein in the first step, the second hole is formed such that a length in a [0 0 1] direction is substantially equal to a length from an end of the second hole on a first face side where the first face is provided to an end of the first hole in the [1 0 0] direction.

3. The method for manufacturing a nozzle plate according to claim 1,
wherein in the first step, the second hole is formed such that a length in a [0 0 1] direction is longer than a length from an end of the second hole on a first face side where the first face is provided to an end of the first hole in the [1 0 0] direction, and
wherein a step face is formed on the nozzle tapered portion.

4. The method for manufacturing a nozzle plate according to claim 1, wherein centers of the first hole and the second hole coincide with one another.

5. The method for manufacturing a nozzle plate according to claim 1, wherein in the first step, a bottom portion of the first hole is formed stepwise.

6. The method for manufacturing a nozzle plate according to claim 1,
wherein the first step includes:
forming a third hole by deep-drilling the single-crystal silicon substrate partway from the first face by dry etching;
subsequently forming a nozzle mask layer along an inner face of the third hole; and
subsequently removing the nozzle mask layer formed on a bottom portion of the third hole,
wherein the first hole is formed by further deep-drilling the third hole, and
wherein in the second step, the nozzle channel including a nozzle straight portion continuous from an end of the nozzle tapered portion on a second face side where the second face is provided is formed.

7. The method for manufacturing a nozzle plate according to claim 1, wherein in the single-crystal silicon substrate, a non-wet etching layer is formed from the second face.

8. The method for manufacturing a nozzle plate according to claim 1, further comprising a third step of enlarging a diameter of an opening of the nozzle channel on a first face side where the first face is provided and/or a second face side where the second face side is provided.
